(19) United States
(12) Patent Application Publication
(10) Pub. No.: US 2010/0061636 A1
(43) Pub. Date: Mar. 11, 2010

(54) FACE DETECTOR AND FACE DETECTING METHOD

(76) Inventors: Toshimitsu FUKUSHIMA, Kanagawa (JP); Takashi Miyamoto, Kanagawa (JP)

Correspondence Address: BIRCH STEWART KOLASCH & BIRCH, PO BOX 747, FALLS CHURCH, VA, 22040-0747, US

(21) Appl. No.: 12/555,334

(22) Filed: Sep. 8, 2009

(30) Foreign Application Priority Data
Sep. 9, 2008 (JP) 2008-230665

(51) Int. Cl. G06K 9/46

(52) U.S. Cl. 382/190; 382/209

(57) ABSTRACT

A face detector includes a detection processor for detecting a facial image from a frame of a motion picture according to template matching by use of a parameter, or a window size and window shift of a window. A parameter controller assigns the detection processor with a predetermined normal variation range of the parameter, to carry out face detection of a first frame of the motion picture according to the normal variation range, determines a limited variation range smaller than the normal variation range according to at least one of a value of the parameter used for the face detection of the first frame and the facial image of the first frame. The detection processor is assigned with the limited variation range, to carry out face detection of a succeeding frame after the first frame of the motion picture according to the limited variation range.

### BACKGROUND OF THE INVENTION

1. Field of the Invention

The present invention relates to a face detector and face detecting method. More particularly, the present invention relates to a face detector and face detecting method in which a face of a person can be detected from frames of a motion picture with high precision.

2. Description Related to the Prior Art

In an imaging instrument such as a digital video camera and digital still camera, a facial image of a person is detected from a motion picture or still image, for the purpose of performing tasks of processing in various functions, for example, auto focusing for focusing a face of a person as an object automatically, exposure adjustment and white balance correction for finely reproducing the facial image. Also, there is a known technique in which a direction of imaging is changed according to motion of a face for monitoring the motion of a person.

Template matching is a method as an example of face detection of a human face. A window or a quadrilateral area is displayed in an object image and shifted stepwise in a window shift of a constant value. A window image is derived by cropping an image portion according to each of locations of windows. Correlation of the window image with a template image is obtained by calculation. One of the window images with high correlation with the template image is determined as the facial image. An example of the template image for detecting a face of a random person is information of an average image of facial images of a great number of persons.

In general, sizes of the facial image of persons are not constant according to an object distance and others. The face detection is carried out by successively changing the ratio of the size of the object image to the size of the window. An example of method of changing the ratio is a method of using a window of a constant size relative to enlarged or reduced images obtained from the object image with various values of magnifications. In another example, windows of various sizes are used relative to the object image of a constant size.

In the template matching, a great number of the window images are obtained by cropping, and correlation of the window image with the template image is evaluated by changing a ratio of a size of the object image with a size of the window. If the face detection with high precision is required, it is likely that the number of steps of arithmetic operation may be excessively high. It will be impossible to process the motion picture in a short time, for example, in one frame period. Long time required for the arithmetic operation is a problem in processing the motion picture.

In view of this problem, U.S.P. No. 2006/028576 (corresponding to JP-A 2006-025238) discloses the face detection in an image pickup apparatus in which a size of a face of a person in an image is detected according to an object distance expressed by information of an in-focus position and information of an angle of view, and the face is detected by use of a window of the size of the face.

In the face detection of JP-A 2006-228061, local portions of a face are tracked in a search area determined according to a location of a previously detected local portion. At first, a face is detected from an initially input image. Then locations of individual local portions are detected from the face. According to the locations of the detected local portions, a search area is determined in one portion of the input image. For succeeding images, local portions are tracked in the search area.

JP-A 2003-271933 discloses the face detection in which a particular face is detected. A plurality of the window images are derived, and processed in the template matching initially for removing an overlapped portion from the window images. Otherwise, one of the window images having high correlation is selectively designated in case of presence of an overlapped portion between the window images. The pattern recognition, for example, the support vector machine (SVM) analysis, is utilized for detecting specific one of the facial image.

However, U.S.P. No. 2006/028576 (corresponding to JP-A 2006-025238) is unsuitable for detecting faces of plural persons different in the distance by use of the depth of field. Also, images without information of an in-focus position and information of the angle of view cannot be detected because of its requirement for the detection. JP-A 2006-228061 has a problem in that the facial image is likely to be missed from the determined search area typically when motion of a person is remarkably great. The number of steps of arithmetic operation cannot be reduced because detection must be carried out for the entirety of an image. JP-A 2003-271933 cannot be used for the face detection of a face of a random person.

### SUMMARY OF THE INVENTION

In view of the foregoing problems, an object of the present invention is to provide a face detector and face detecting method in which a face of a person can be detected from frames of a motion picture with high precision.

In order to achieve the above and other objects and advantages of this invention, a face detector includes a detection processor for detecting a facial image from a frame of a motion picture according to template matching by use of a parameter. A parameter controller assigns the detection processor with a predetermined normal variation range of the parameter, to carry out face detection of a first frame of the motion picture according to the normal variation range, for determining a limited variation range smaller than the normal variation range according to at least one of a value of the parameter used for the face detection of the first frame and a status of the facial image of the first frame, and for assigning the detection processor with the limited variation range, to carry out face detection of a succeeding frame after the first frame of the motion picture according to the limited variation range.

The limited variation range is a history-based range according to detection history of the face detection of the facial image for the first frame, to quicken processing of the face detection for the succeeding frame.

Furthermore, a timer measures data processing time required for detecting the facial image from the first frame. If the data processing time is equal to or shorter than one frame period of the motion picture, the parameter controller allocates the succeeding frame for the first frame and assigns the detection processor with the normal variation range.

In one preferred embodiment, furthermore, a timer measures data processing time required for detecting the facial image from the first frame. The parameter controller changes limitation of the limited variation range according to the data processing time to determine the limited variation range.

In another preferred embodiment, furthermore, a timer measures data processing time required for detecting the facial image from the first frame. The parameter controller compares the data processing time with reference time, and if the data processing time is shorter than the reference time, assigns the limited variation range, and if the data processing time is equal to or longer than the reference time, assigns a specific limited variation range smaller than the limited variation range.

The parameter controller checks acceptability of a result of the face detection of the succeeding frame according to assignment of the limited variation range, and if the result is unacceptable in comparison with a result of the face detection of a frame before the succeeding frame, assigns the detection processor with the normal variation range.

The parameter controller checks acceptability of a result of the face detection of the succeeding frame upon detecting the facial image, and if the result is unacceptable, allocates the succeeding frame for the first frame for the face detection.

The parameter in the normal variation range is plural window sizes. The detection processor shifts a window of each of the window sizes in the first frame for the template matching. The limited variation range is constituted by at least one window size selected from the plural window sizes.

The parameter in the normal variation range is plural window shifts with which a window is shifted stepwise. The detection processor shifts the window with each of the window shifts in the first frame for the template matching. The limited variation range is constituted by at least one window shift selected from the plural window shifts.

In one aspect of the invention, a face detecting method includes a step of detecting a facial image from a first frame of a motion picture according to template matching by use of a parameter within a predetermined normal variation range. A limited variation range is determined smaller than the normal variation range according to at least one of a value of the parameter used for the face detection of the first frame and a status of the facial image of the first frame. A facial image is detected from a succeeding frame after the first frame of the motion picture according to the template matching by use of the parameter within the limited variation range.

The parameter in the normal variation range is plural window sizes. In the face detection, a window of each of the window sizes is shifted in the first frame for the template matching. The limited variation range is constituted by at least one window size selected from the plural window sizes.

The parameter in the normal variation range is plural window shifts with which a window is shifted stepwise. In the face detection, the window is shifted with each of the window shifts in the first frame for the template matching. The limited variation range is constituted by at least one window shift selected from the plural window shifts.

Also, a computer executable program for face detection is provided, and includes a program code for detecting a facial image from a frame of a motion picture according to template matching by use of a parameter within a predetermined normal variation range. A program code is for determining a limited variation range smaller than the normal variation range according to at least one of a value of the parameter used for the face detection of the first frame and a status of the facial image of the first frame. A program code is for detecting a facial image from a succeeding frame after the first frame of the motion picture according to template matching by use of the parameter within the limited variation range.

In another aspect of the invention, an object detector includes a detection processor for detecting a region of interest from a frame of a motion picture according to template matching by use of a parameter. A parameter controller assigns the detection processor with a predetermined normal variation range of the parameter, to carry out object detection of a first frame of the motion picture according to the normal variation range, determines a limited variation range smaller than the normal variation range according to at least one of a value of the parameter used for the object detection of the first frame and a status of the region of interest of the first frame, and assigns the detection processor with the limited variation range, to carry out object detection of a succeeding frame after the first frame of the motion picture according to the limited variation range.

Consequently, a face of a person can be detected from frames of a motion picture with high precision, because of utilizing the limited variation range of the parameter for finely searching partial areas in a frame to be analyzed.

### BRIEF DESCRIPTION OF THE DRAWINGS

The above objects and advantages of the present invention will become more apparent from the following detailed description when read in connection with the accompanying drawings, in which:

FIG. 1 is a block diagram illustrating a face detector of the invention;

FIG. 2 is a plan illustrating scanning of a frame for template matching;

FIG. 3 is a flow chart illustrating face detection;

FIG. 4A is a chart illustrating parameters for the face detection in a normal mode;

FIGS. 4B and 4C are charts illustrating parameters for the face detection changed over for a rapid mode;

FIG. 5 is a flow chart illustrating a preferred embodiment in which limitation of parameters is changed over;

FIG. 6 is a flow chart illustrating changes in the parameters in the embodiment of FIG. 5;

FIG. 7 is a flow chart illustrating a preferred embodiment in which the limited variation range of the parameters is changeable;

FIG. 8 is a flow chart illustrating a preferred embodiment in which changes in the parameters in the embodiment of FIG. 7;

FIG. 9 is a flow chart illustrating a preferred embodiment in which acceptability of a result of face detection is checked.

### DETAILED DESCRIPTION OF THE PREFERRED EMBODIMENT(S) OF THE PRESENT INVENTION

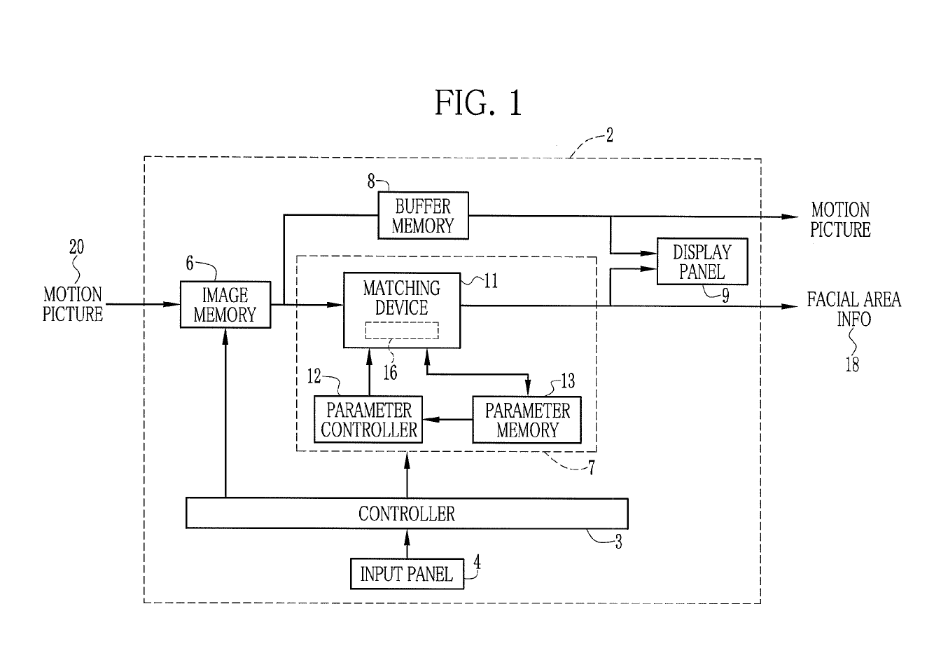

In FIG. 1, a face detector 2 of the invention is illustrated. The face detector 2 carries out template matching of frame images constituting a motion picture 20. A facial image is detected by the face detector 2 according to a technique of face detection. The face detector 2 outputs facial area information 18 of an area of the facial image. An input panel 4 is manually operable and generates input signals for control. A controller 3 responds to the input signals from the input panel 4, and controls various elements in the face detector 2.

Modes of the face detector 2 are a normal mode and a rapid mode. When the normal mode is set, priority is set for precision in detecting a face over data processing time required for face detection. When the rapid mode is set, priority to the data processing time is set for face detection of frame images of frames at a frame rate of the motion picture 20.

As a given selected frame of the motion picture 20, one first frame of the motion picture 20 being input is designated, or a first frame upon changeover to the normal mode from the rapid mode is designated. For the given frame, face detection is carried out in the normal mode. If the data processing time of one frame is equal to or shorter than a prescribed time Ta in the normal mode, then face detection is carried out in the normal mode also for a frame next to this frame. Thus, a frame succeeding to a frame, of which the data processing time is equal to or shorter than the prescribed time Ta, is allocated for a new selected frame. If the data processing time is longer than the prescribed time Ta in the normal mode, then the rapid mode is used for frame images of succeeding frames. Note that the prescribed time Ta is 0.033 second being equal to a frame period of one frame corresponding to 30 fps as frame rate of the image pickup, but can be set shorter than the frame period of one frame.

There is an image memory 6 to which motion picture 20 is input by an external device as a target of the face detection, and written in a format of image data. The controller 3 operates for control with the image memory 6 so that frame images are read from the image memory 6 and output by one frame as frames or components of the motion picture 20. Frame images are output normally at a normal frame rate, for example per 1/30 second. In the normal mode, a frame image of a succeeding frame is prevented from being output by the control before the face detection of one frame image is completed.

A detection processor 7 or data processor is supplied with information of frame images from the image memory 6 one after another. The detection processor 7 carries out template matching of the frame images, detects a facial image in the frame images, and outputs facial area information 18 of the facial image.

A buffer memory 8 is incorporated for synchronization of outputs of an image and facial area information 18. The buffer memory 8 temporarily stores the image from the image memory 6. The image is read from the buffer memory 8 in response to outputting of the facial area information 18 associated with the image from the detection processor 7, and is output externally. Thus, the face detector 2 outputs the motion picture 20 at 30 fps normally together with the facial area information 18.

A display panel 9 is supplied with the facial area information 18 by the detection processor 7 and with information of images from the buffer memory 8. An example of the display panel 9 is a liquid crystal display panel or the like. A driver drives the display panel 9. The display panel 9 displays an image input from the buffer memory 8 one after another, and also indicates frame lines of a window overlapped on the image and produced according to the facial area information 18. A user can observe the images and the window in the display panel 9 and checks a detected status of the facial image.

An example of the detection processor 7 is constituted by a digital signal processor of a high speed, a memory and other elements. There are a matching device 11, a parameter controller 12 and a parameter memory 13 incorporated in the detection processor 7. The matching device 11 is supplied with frame images from the image memory 6 one frame after another. A template image is stored in the matching device 11 as information produced as an average facial image from a great number of faces of persons. The matching device 11 carries out the template matching of input frame images, and detects an area of the facial image in the frame images.

Note that the template image is herein used in a reduced or enlarged state for a size equal to a window size which will be described in detail. Alternatively, it is possible to prepare and store template images of sizes equal to window sizes for use.

In the template matching, correlation is checked between the template image and a window image cropped from a frame image by use of a window or quadrilateral area, to check whether the window image is a facial image of a person. The detected area of the facial image is output as facial area information 18 related to a size, position and the like of the facial image.

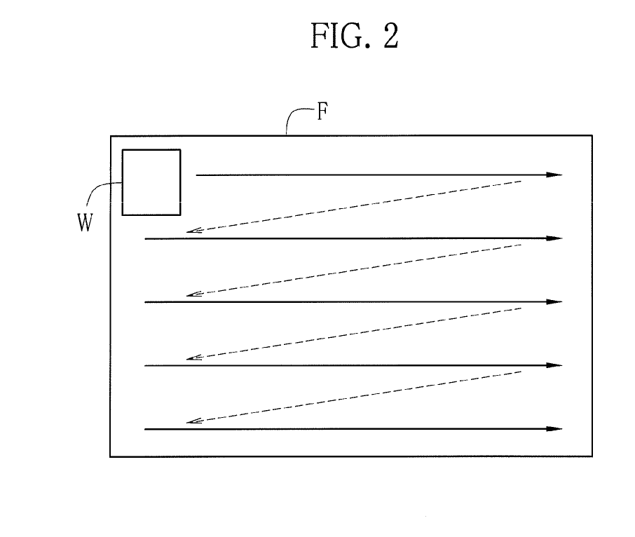

For template matching, the matching device 11 shifts the window W from the upper left corner toward the lower right corner of the frame image F to scan, as illustrated in FIG. 2. Window images are cropped and checked for the correlation with the template image. Specifically in the scanning, the window W is shifted from the left end toward the right stepwise with a window shift of a given value, and upon reach to the right end, is set back to the left end and shifted down as much as the window shift, and then shifted toward the right stepwise again.

Variable parameters are constituted by the window size and the window shift of the window W. The matching device 11 operates for scanning by combination of the window size and the window shift in their assigned variation ranges.

The matching device 11 scans for the template matching with the largest window size and the largest window shift initially. If correlation information between the window image and the template image in a first area is equal to or higher than a first threshold, then the matching device 11 determines the first area as a facial area. If the correlation information between the window image and the template image in a second area is equal to or higher than a second threshold and lower than the first threshold, then the matching device 11 determines the second area as an area with a candidate face. The matching device 11 further scans the second area with changes in the window size and window shift.

The parameter controller 12 determines a variation range within which a parameter should vary, and assigns the matching device 11 with the variation range. The parameter controller 12 stores information of a variation range of a window size for a normal mode, and a variation range of a window shift. In the normal mode, the parameter controller 12 assigns the matching device 11 with the variation ranges of the window size and the window shift for the normal mode.

Variation ranges of the window size and window shift for the normal mode described above are predetermined in order to detect a face with high precision. For example, the variation range of the window size is from 100×100 pixels to 15×15 pixels. The variation range of the window shift is from 5 pixels to 1 pixel. The matching device 11 changes over the window size stepwise at 5 pixels, and changes over the window shift stepwise at 1 pixel.

If data processing time in the normal mode is longer than the prescribed time Ta, the parameter controller 12 determines history-based limited variation ranges for succeeding frames. This is effective in quickening the data processing. The limited variation ranges include that of the window size and that of the window shift for the rapid mode, namely ranges in which values of the parameters are limited in comparison with the normal mode. The parameter controller 12 assigns the matching device 11 with information of the limited variation ranges.

In the template matching of the matching device 11, areas are scanned with the adjusted window size and window shift, the areas including candidate faces detected by scanning according to the initially largest window size and window shift. Accordingly, the data processing time changes with an increase or decrease by changes of the area and number of times of scanning according to the number of faces included in an image.

The variation range of the window size for the rapid mode is determined smaller than that for the normal mode and inclusive of reference window sizes, namely specific window sizes in a previous face detection in the normal mode for a facial image. Specifically, the variation range of the window size for the rapid mode is so determined that its upper limit is equal to a size one step larger than a maximum of the reference window sizes, and its lower limit is equal to a size one step smaller than a minimum of the reference window sizes. Also, the window shift for the rapid mode is fixedly determined as a single value, for example three pixels.

For a variation range of the window size, as one of the parameters in the invention, an active or inactive state of its limitation is determined according to data processing time as one result of the face detection. The history-based limited variation range of the window size is determined according to a value of the window size upon detection of the facial image. For the window shift, as one of the parameters in the invention, an active or inactive state of its limitation is determined according to the data processing time as one result of the face detection. The window shift is determined again at a constant value.

The parameter memory 13 stores information of the reference window size, a reference window shift as a specific value of the window shift upon the face detection, and the data processing time written by the matching device 11. The information stored in the parameter memory 13 is renewed according to a result of the template matching for a new frame image in the normal mode. The information stored in the parameter memory 13 is readable by the parameter controller 12. Note that a timer 16 in the matching device 11 measures the data processing time.

The operation of the embodiment is described now. At first, motion picture 20 for use in the face detection is written to and stored in the image memory 6. When writing of the motion picture 20 is completed, frame images are read from the image memory 6 frame after frame, and input to the detection processor 7 and the buffer memory 8 serially. The detection processor 7 starts operation of the face detection.

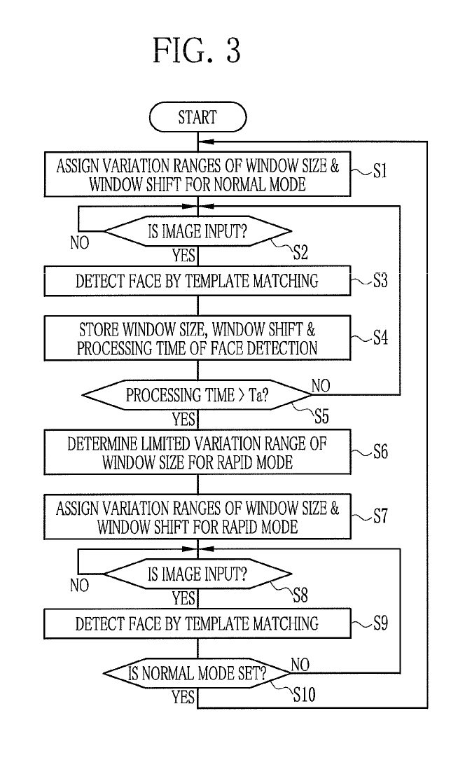

At the start of the face detection, the normal mode is set initially. In FIG. 3, the variation ranges of the window size and the window shift for the normal mode are assigned by the parameter controller 12 to the matching device 11 in the step S1. In the step S2, an input of a frame image of a first frame is recognized. The matching device 11 operates for template matching, to detect a facial image of a person within the frame image in the step S3.

In the template matching, the variation ranges of the window size and window shift for the normal mode are assigned. Images are scanned according to the combined variation ranges of the window size and window shift. At first, the images are scanned by use of a window with the window size of 100×100 pixels and the window shift of 5 pixels. Window images are sequentially obtained by scanning, and are evaluated for correlation with the template image. If information of the correlation is equal to or higher than a first threshold, then a window image is determined as facial image of a person, so that a position and size of the facial image are output as facial area information 18. If the information of the correlation is equal to or higher than a second threshold and lower than the first threshold, then a window image is determined as an image of a candidate face of a person.

Upon completing the scan of the first time, areas with a candidate face according to preliminary detection are scanned with the window shift of 5 pixels and with the window size of 95×95 pixels, 90×90 pixels, . . . , and 15×15 pixels one after another. After this, the window shift is changed from 4, 3 and 2 pixels to 1 pixel. The window size is changed in a variation range from 95×95 pixels to 15×15 pixels.

Window images, of which correlation information is equal to or higher than the first threshold according to scan, are determined as facial images of persons. Facial area information 18 of the facial images is output. As a result, a plurality of facial images are respectively detected when present in a frame image. A set of facial area information 18 of each of the facial images is output. The facial images can be detected with high precision, because the variation ranges of the window size and window shift for the normal mode are determined and assigned.

When the template matching for the first frame image is completed, the matching device 11 writes information of the window size upon detecting the facial image of a person to the parameter memory 13 as a reference window size. The matching device 11 writes information of the window shift to the parameter memory 13 as a reference window shift. The matching device 11 writes data processing time required for the template matching of the first frame image to the parameter memory 13. See the step S4.

After writing of the reference window size, the reference window shift and the data processing time, the parameter controller 12 reads the data processing time stored in the parameter memory 13, and checks whether the data processing time is equal to or shorter than the prescribed time Ta or frame period in the step S5.

If the data processing time is equal to or shorter than the prescribed time Ta, the normal mode is maintained. When reception of a frame image of a second frame is detected in the step S2, then the template matching is carried out in the step S3. With the assigned variation ranges of the window size and the window shift for the normal mode, the template matching of the matching device 11 is carried out in a manner similar to the above. In the step S4, the parameter memory 13 is accessed to store information of the reference window size, the reference window shift and the data processing time for a frame image of a second frame. It is checked in the step S5 whether the data processing time is equal to or lower than the prescribed time Ta.

As described above, if the data processing time is equal to or shorter than the prescribed time Ta in the normal mode, the frame rate of the motion picture 20 can be maintained constantly for images input one after another. Thus, a facial image of a person is detected according to the assigned variation ranges of the window size and window shift for the normal mode for possibility of high precision.

In the normal mode, if the data processing time for a frame image of an Nth frame is longer than the prescribed time Ta, then a rapid mode is set for succeeding frames in order to maintain a predetermined frame rate of the motion picture 20.

In the rapid mode, data processing is quickened by history-based limitation. The parameter controller 12 determines a variation range of the window size for the rapid mode according to the reference window sizes obtained by designating an Nth frame for detection. A window shift for the rapid mode is set only with three (3) pixels in the step S6. The matching device 11 is assigned with the variation range of the window size for the rapid mode and the window shift in the step S7.

When reception of an image of an (N+1)th frame is detected in the step S8, the matching device 11 carries out the template matching in the step S9 by use of the window size and window shift of the assigned variation ranges. In case of correlation of a predetermined level or higher, window images are determined as the facial images of persons. Facial area information 18 corresponding to those is output.

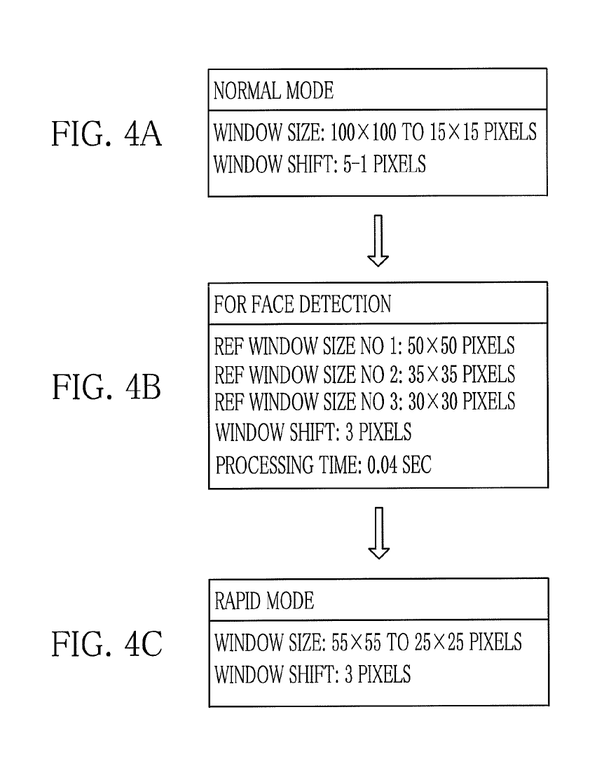

In FIG. 4A, the normal mode is set for the Nth frame. Template matching is carried out with the variation range of the window size from 100×100 pixels to 15×15 pixels and with the variation range of the window shift from 5 pixels to 1 pixel. See FIG. 4B. For example, faces of three persons are detected from a frame image of the Nth frame. Window sizes for detection of those are 50×50, 35×35 and 30×30 pixels. A window shift is three (3) pixels. The data processing time is 0.04 second.

In the above situation, the data processing time is longer than the prescribed time Ta=0.033 second. For an (N+1)th frame, an image is processed in the template matching in the rapid mode. As the window size used for detecting a facial image is 50×50, 35×35 and 30×30 pixels, the variation range of the window size for the rapid mode is determined from 55×55 pixels to 25×25 pixels. See FIG. 4C. Also, the window shift is determined as 3 pixels.

When the template matching for a frame image of the (N+1)th frame is completed by use of the variation ranges of the window size and the limited window shift for the rapid mode, then an active or inactive state of designating the normal mode is checked in the step S10. In the case of no designation of the normal mode, the operation returns to the step S8 to stand by for an input of a frame image of an (N+2)th frame. When the frame image of the (N+2)th frame is input, the template matching of the frame image in the rapid mode is carried out. The facial image of a person is detected with the variation ranges of the window size and window shift determined for the rapid mode.

Similarly, the template matching is carried out by use of the variation ranges of the window size and the window shift for the rapid mode before next designation of the normal mode. The window size and the window shift used in the rapid mode are in the history-based limited variation ranges in comparison with the normal mode. Thus, the face detection is possible in the data processing time suitable for maintaining the predetermined frame rate for frame images. Sufficiently high precision in the detection can be maintained, because the window size of the history-based limited variation range is derived from the window size at the time of having detected the facial image in the normal mode with the higher precision.

During the template matching, an image from the buffer memory 8 and facial area information 18 are synchronized and output by the face detector 2, the facial area information 18 being generated by the detection processor 7 in association with the image. Only when the data processing time is longer than the prescribed time Ta in the normal mode, the frame rate changes. Otherwise, the motion picture 20 at a frame rate maintained at a constant value can be output together with the facial area information 18.

The display panel 9 displays frame lines overlapped on the motion picture 20 according to the facial area information 18 for indicating a facial area of a person. If no frame lines are displayed in relation to a face of a person of interest, or no frame lines are associated with a displayed face of a person of interest, then an operator sets a normal mode by operating the input panel 4.

When a setting of the normal mode is instructed, the matching device 11 is assigned with variation ranges of the window size and window shift for the normal mode by return from the step S10 to the step S1. The template matching in the normal mode is carried out in a manner similar to the above steps. A facial image of a person who has not been detected can be targeted for detection.

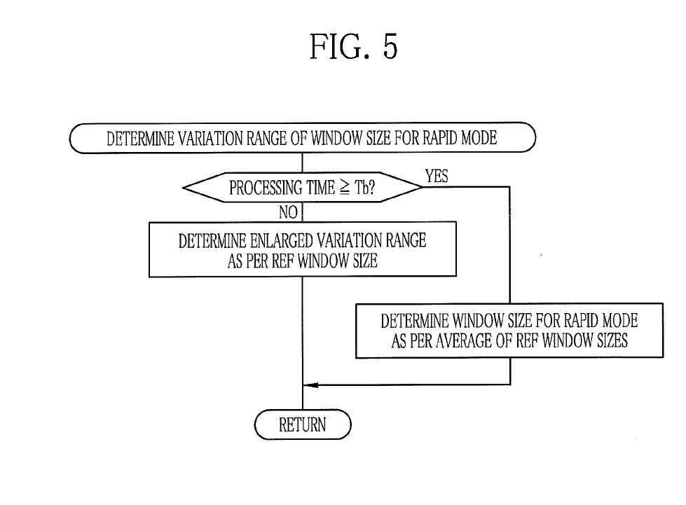

In FIG. 5, a preferred embodiment is illustrated in which a variation range of the window size for the rapid mode is changed over according to data processing time as one result of the detection. In the embodiment, information of the data processing time stored in the parameter memory 13 is referred to at the time of determining a variation range of the window size for the rapid mode, and is compared with the reference time Tb. The reference time Tb is a basis for estimating the amount of reduction of the data processing time, and is predetermined longer than the prescribed time Ta (Tb>Ta).

If the data processing time is shorter than the reference time Tb according to the comparison, then the variation range of the window size for the rapid mode is determined equally to the above embodiment in such a manner that its upper limit is equal to a size one step larger than a maximum of the reference window sizes, and its lower limit is equal to a size one step smaller than a minimum of the reference window sizes.

If the data processing time is equal to or longer than the reference time Tb, an average of the reference window sizes is determined as one fixed value or limited variation range of the window size for the rapid mode, so as to reduce the data processing time remarkably.

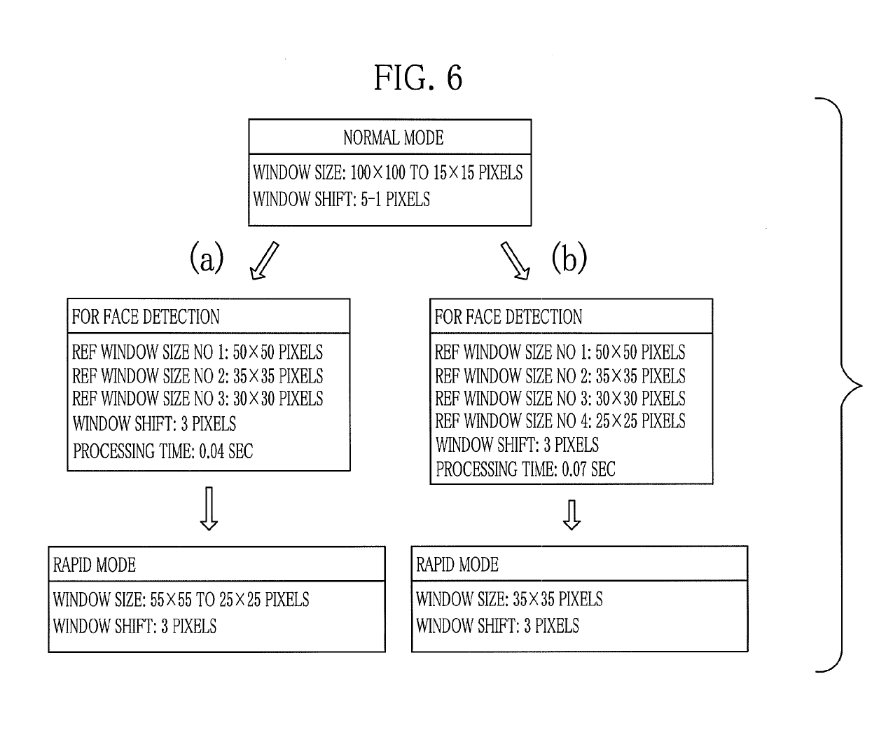

For example, the reference time Tb is 0.055 second. The data processing time is 0.04 second in the section [a] of FIG. 6. In this situation, the data processing time is shorter than the reference time Tb, and is determined with a small difference from the prescribed time Ta. Then a variation range of the window size for the rapid mode is from 55×55 pixels to 25×25 pixels as a range being one step larger than the reference window size. In another situation, the data processing time is 0.07 second in the section [b] of FIG. 6 and is equal to or longer than the reference time Tb. The data processing time is determined with a great difference from the prescribed time Ta. Then a variation range of the window size for the rapid mode is a fixed value of only 35×35 pixels as an average of the reference window sizes.

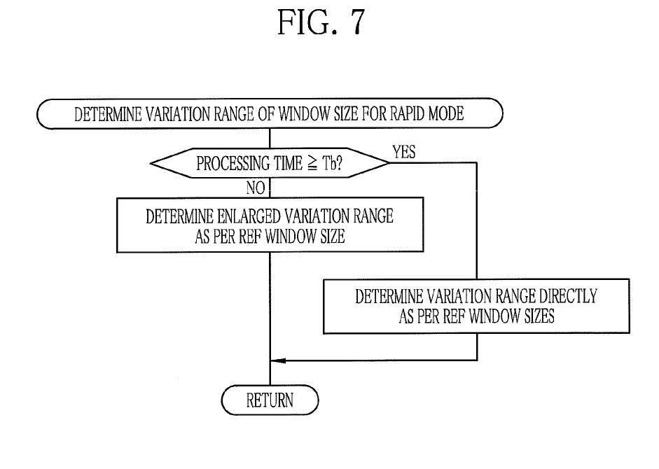

In FIG. 7, an example is illustrated, in which limitation of the variation range of the window size for the rapid mode is changeable according to the data processing time as one result of the face detection. In the example, information of the data processing time stored in the parameter memory 13 is referred to at the time of determining a variation range of the window size for the rapid mode, and is compared with the reference time Tb which is different from the prescribed time Ta with a great difference.

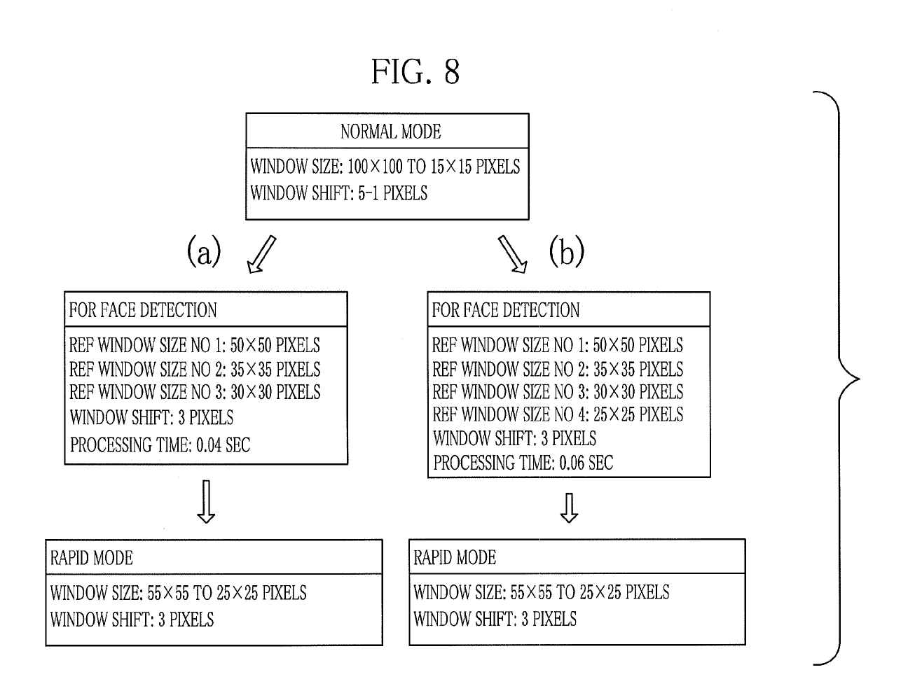

If the data processing time is shorter than the reference time Tb according to the comparison, then a variation range of the window size for the rapid mode is so determined that its upper limit is equal to a size one step larger than a maximum of the reference window sizes, and its lower limit is equal to a size one step smaller than a minimum of the reference window sizes. According to the reference window sizes in the normal mode such as 50×50, 35×35 and 30×30 pixels as illustrated in FIG. 8, a variation range of the window size for the rapid mode is set from 55×55 pixels to 25×25 pixels as illustrated in the section [a] of FIG. 8.

If the data processing time is equal to or longer than the reference time Tb, then the variation range of the window size for the rapid mode is determined by deriving an upper limit from a maximum of the reference window sizes and by deriving a lower limit from a minimum of the reference window sizes. This reduces the variation range of the window size more remarkably. See the section [b] of FIG. 8. When the reference window sizes are 50×50, 35×35, 30×30 and 25×25 pixels, then the variation range of the window size for the rapid mode is from 50×50 pixels to 25×25 pixels.

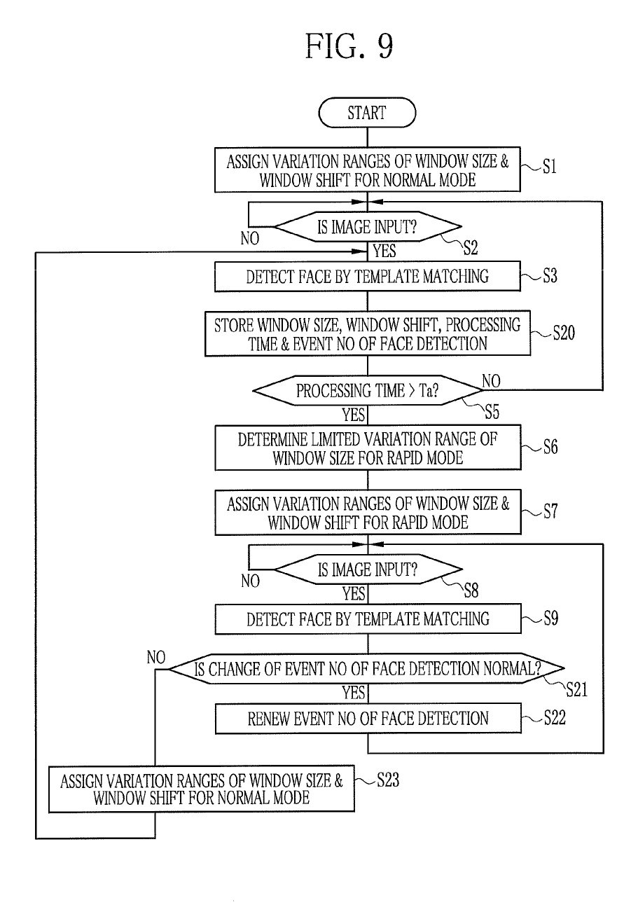

In FIG. 9, another preferred embodiment is illustrated, in which acceptability of a result of the face detection of the facial image in the rapid mode is checked. In case of no acceptability, a frame after this face detection is subjected in the face detection in the normal mode. Differences of the present embodiment from the first embodiment will be described in detail. Elements similar to those of the first embodiment are designated with identical reference numerals in FIG. 8.

Upon detecting the facial image of a person in the normal mode, the number of the facial images being detected or the event number of face detection is written to the parameter memory 13 in the step S20 as a reference event number of face detection. In the rapid mode, the event number of face detection according to the template matching for respective frames is compared in the step S21 with the reference event number stored in the parameter memory 13, for checking acceptability of an increase or decrease. In case of confirming the acceptability, it is judged that a result of the detection is acceptable. The reference event number in the parameter memory 13 is renewed by a result of the face detection in the step S22, to carry out the face detection of a succeeding frame in the rapid mode.

If an unacceptable state is detected in the step S21 because of no acceptability of the result of the face detection in the rapid mode, then the matching device 11 is assigned with the variation ranges of the window size and window shift for the normal mode in the step S23. The normal mode is set, in which template matching is carried out from an unacceptable frame image. For changes in the number of the facial images detected in the step S21, an unacceptable state is detected if the event number of face detection is remarkably lower than the reference event number, for example, has become under 50% as much as the reference event number.

When the template matching is carried out in the rapid mode in the embodiment, the event number of face detection of a present frame image is compared with the event number of face detection of a frame image of a frame directly prior to the present frame image, to check acceptability of a result of the detection. In case of no acceptability, the present frame image is processed in the template matching in the normal mode. This is effective in keeping reliability in the face detection without drop as well as reducing the data processing time to maintain the predetermined frame rate.

In the above embodiment, acceptability of a result of the face detection in the rapid mode is checked according to an increase or decrease of the event number of face detection of the facial images of a person. However, various methods can be used for checking acceptability. In an example of checking method, a difference between a first window size of the facial image of a present frame image and a second window size of the facial image of a frame image prior to the present frame image is evaluated. If the difference is more than a tolerable value, then it is judged that there is no acceptability. In another example of checking method, a difference between a first location of the facial image of a present frame image and a second location of the facial image of a frame image prior to the present frame image is evaluated. If the difference is more than a tolerable value, then it is judged that there is no acceptability. Furthermore, it is possible for a user to select or designate a preferred one of plural checking methods for acceptability. In case of no acceptability, it is possible to change over to the normal mode in which succeeding frame images next to the present frame image can be subjected to the face detection.

Note that the invention is not limited to the above-described method, status and the like of quickening data processing with history-based limited variation ranges of the window size and the window shift. For example, a window size and a window shift equal to respectively the reference window size and reference window shift can be used for template matching in the rapid mode. It is possible to consider a first one of the reference window size and reference window shift of the window size and window shift for determining a history-based limited variation range of a second one of the window size and window shift. To this end, it is preferable to suppress drop in the precision of detecting the facial image of a person by maintaining the predetermined frame rate.

Note that the variable parameters in the invention are other values or characteristics than the window size and window shift of the window of the above embodiments. The method of the template matching is not limited to that of the above embodiments. Other methods may be used for detecting the facial image of a person by use of a variable parameter for face detection of the facial image of a person. For example, face detection disclosed in U.S. Pat. No. 5,309,228 (corresponding to JP-A 5-158164), JP-A 7-306483 and the like can be utilized.

Also, a face detecting method of the invention can be used in an optical instrument for taking an image, for example, a cellular phone having a component of a camera. Furthermore, a personal computer can function as a face detector by suitably installing a computer program for face detection.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A face detector comprising:
a detection processor for detecting a facial image from a frame of a motion picture according to template matching by use of a parameter; and
a parameter controller for assigning said detection processor with a predetermined normal variation range of said parameter, to carry out face detection of a first frame of said motion picture according to said normal variation range, for determining a limited variation range smaller than said normal variation range according to at least one of a value of said parameter used for said face detection of said first frame and a status of said facial image of said first frame, and for assigning said detection processor with said limited variation range, to carry out face detection of a succeeding frame after said first frame of said motion picture according to said limited variation range.

2. A face detector as defined in claim 1, wherein said limited variation range is a history-based range according to detection history of said face detection of said facial image for said first frame, to quicken processing of said face detection for said succeeding frame.

3. A face detector as defined in claim 1, further comprising a timer for measuring data processing time required for detecting said facial image from said first frame;
if said data processing time is equal to or shorter than one frame period of said motion picture, said parameter controller allocates said succeeding frame for said first frame and assigns said detection processor with said normal variation range.

4. A face detector as defined in claim 1, further comprising a timer for measuring data processing time required for detecting said facial image from said first frame;
wherein said parameter controller changes limitation of said limited variation range according to said data processing time to determine said limited variation range.

5. A face detector as defined in claim 1, further comprising a timer for measuring data processing time required for detecting said facial image from said first frame;
wherein said parameter controller compares said data processing time with reference time, and if said data processing time is shorter than said reference time, assigns said limited variation range, and if said data processing time is equal to or longer than said reference time, assigns a specific limited variation range smaller than said limited variation range.

6. A face detector as defined in claim 1, wherein said parameter controller checks acceptability of a result of said face detection of said succeeding frame according to assignment of said limited variation range, and if said result is unacceptable in comparison with a result of said face detection of a frame before said succeeding frame, assigns said detection processor with said normal variation range.

7. A face detector as defined in claim 6, wherein said parameter controller checks acceptability of a result of said face detection of said succeeding frame upon detecting said facial image, and if said result is unacceptable, allocates said succeeding frame for said first frame for said face detection.

8. A face detector as defined in claim 1, wherein said parameter in said normal variation range is plural window sizes;
said detection processor shifts a window of each of said window sizes in said first frame for said template matching;
said limited variation range is constituted by at least one window size selected from said plural window sizes.

9. A face detector as defined in claim 1, wherein said parameter in said normal variation range is plural window shifts with which a window is shifted stepwise;
said detection processor shifts said window with each of said window shifts in said first frame for said template matching;
said limited variation range is constituted by at least one window shift selected from said plural window shifts.

10. A face detecting method comprising steps of:
detecting a facial image from a first frame of a motion picture according to template matching by use of a parameter within a predetermined normal variation range;
determining a limited variation range smaller than said normal variation range according to at least one of a value of said parameter used for said face detection of said first frame and a status of said facial image of said first frame;
detecting a facial image from a succeeding frame after said first frame of said motion picture according to said template matching by use of said parameter within said limited variation range.

11. A face detecting method as defined in claim 10, wherein said limited variation range is a history-based range according to detection history of said face detection of said facial image for said first frame, to quicken processing of said face detection for said succeeding frame.

12. A face detecting method as defined in claim 10, wherein said parameter in said normal variation range is plural window sizes;
in said face detection, a window of each of said window sizes is shifted in said first frame for said template matching;
said limited variation range is constituted by at least one window size selected from said plural window sizes.

13. A face detecting method as defined in claim 10, wherein said parameter in said normal variation range is plural window shifts with which a window is shifted stepwise;
in said face detection, said window is shifted with each of said window shifts in said first frame for said template matching;
said limited variation range is constituted by at least one window shift selected from said plural window shifts.
